(19) United States
(12) Patent Application Publication
(10) Pub. No.: US 2025/0138855 A1
(43) Pub. Date: May 1, 2025

(54) ZERO TOUCH STORAGE NODE CONTAINERS IN CLOUD NETWORKED STORAGE ENVIRONMENT

(71) Applicant: International Business Machines Corporation, Armonk, NY (US)

(72) Inventors: Angel Nunez Mencias, Stuttgart (DE); Anbazhagan Mani, Bangalore (IN); Subramaniyan Nallasivam, Bangalore (IN); Dileep Dixith, HYDERABAD (IN)

(21) Appl. No.: 18/493,837

(22) Filed: Oct. 25, 2023

(51) Int. Cl. G06F 9/455

(52) U.S. Cl. CPC G06F 9/45558; G06F 2009/45583

(57) ABSTRACT

Validating a distributed computing storage platform with zero-touch storage node containers includes creating a container image having a tools repository. The image is pushed to a repository and the container image is pulled from the repository a local folder. The container image is saved in the local folder. A container is created to import the container image as well as tools repository into storage nodes. An ansible inventory configured to group the plurality of storage nodes is created and an alias for each group in the plurality of storage nodes is created. The container is extracted and the tarball is copied from the container into the storage nodes. The tarball is unzipped on each of the storage nodes in the plurality of storage nodes, and the storage operations are executed. The results of the storage operation are stored. The results of each executed storage operation are collected.

### BACKGROUND

The present invention generally relates to validating a cloud storage platform with zero touch storage.

Distributed computing platforms provide an environment to separate user applications from an infrastructure and consider infrastructure like a managed application. Secure distributed computing platforms don't typically expose the application programming interface (API) to zonal regional layer due to zero-trust guidance, and the storage platform has no access to internet. The limited access nature prevents undesired incursions into the distributed computing network, but also prevents the distributed computing system from being able to pull the tools that are necessary for debugging features within the distributed computing system.

In a distributed storage environment, a check storage log logs or restarts the storage controller process in the case of any detected failure, debugs the storage controller, or runs any tools (e.g., strace) inside the storage platform in case of failures. In addition, a typical debug operation for a complex problem includes saving the system state before logs get cleaned up. The saved system state includes a relevant points snapshot of the system when the problem occurred and restores the snapshot to a standby box and debugs the problem using the snapshot.

### SUMMARY

Embodiments of the present invention are directed to validating a distributed computing storage platform with zero-touch storage node containers by creating a container image including a tools repository, pushing the container image to a repository, pulling the container image from the repository a local folder and saving the container image in the local folder, creating a container to import the container image as well as tools repository into a plurality of storage nodes, creating an ansible inventory configured to group the plurality of storage nodes and creating an alias for each group in the plurality of storage nodes, extracting the container and copying the tarball from the container into the storage nodes, unziping the tarball on each of the storage nodes in the plurality of storage nodes, executing the storage operations and storing results of the storage operations in a specific directory, collecting the results of each executed storage operation, and logging back to the local folder after a command is executed and cleaning up the container. Alternative embodiments of the present invention include systems and machines configured to implement the same process.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 illustrates an embodiment of hierarchical layered distributed computing network environment 200; and

FIG. 3 illustrates one example process 300 for granting the validation ability without user access or login.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Computing environment 100 contains an example of an environment for the execution of at least some of the computer code involved in performing the inventive methods, such as granting a validation ability without user access or login at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 132, virtual machine set 143, and container set 144.

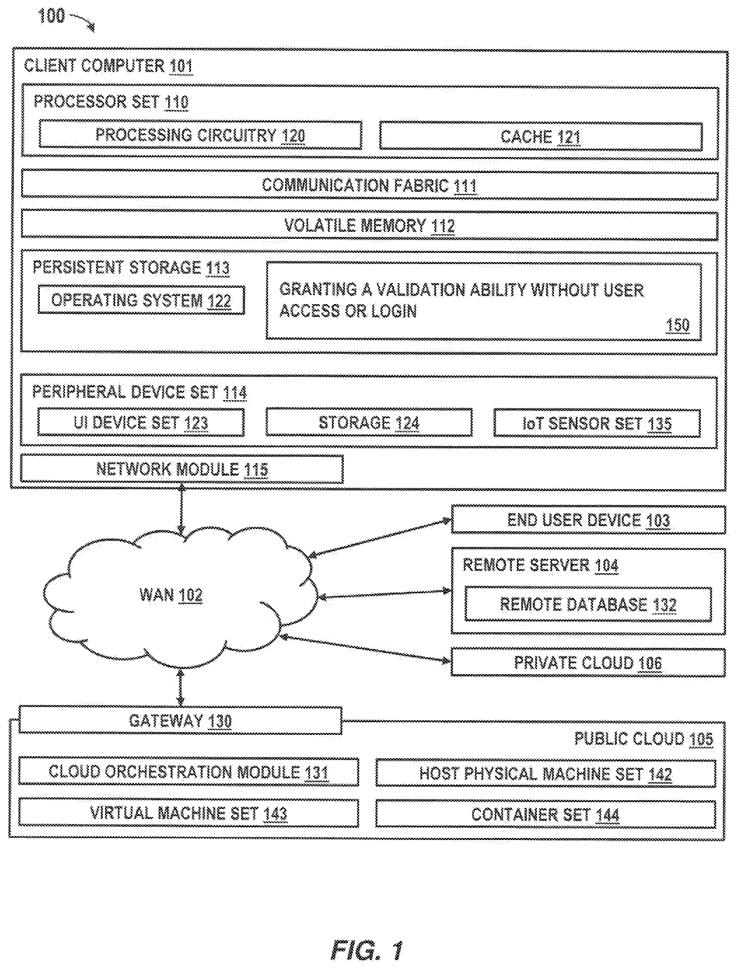

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of distributed computing technologies that are more specifically relevant to aspects of the invention, for each workload, segments of computing resources are allocated which would be consumed by a client application. In a development and testing environment, an experimental workload requires a substantial amount of computing resources and there is often a shortage of resources to implement a given feature.

In addition, there is a significant amount of resources spent on a development cycle for each workload segment. During the development cycle, the resources consumed are significant and it is possible for there to be insufficient capacity and resources to validate and verify the functionality of the feature. A methodology is disclosed herein which creates a container on need basis for a particular functionality to be validated as an objective function. The methodology is based on aggregated inventory and computing resources, in order to achieve maximum utilization of the underlying resources and combine the validation and verification of a functionality in an efficient manner.

In a distributed computing storage system, many controllers are deployed to service the clients with their requests. There are many features that are running in the distributed computing infrastructure including features that are monitoring the system characteristics, requesting an application request through remote procedure call to the underlying platform and receiving the response from the platform, and similar functions.

Platform infrastructure currently exists for developing a functionality and validating the functionality. For example, in a managed application which developer wants to add a new functionality, the storage platform allows the developer to develop the functionality by means of directly interfacing with the platform and doesn't require the developer to go through the infrastructure service. The platform also registers to Kubernetes orchestration, and it has a containerization capability and tooling that can help development team.

A drawback with this model is that a large investment must be done for development and testing to validate the feature. The cost of underlying storage hardware with flash drives as well as the infrastructure cost is expensive. Alternate solutions exists including taking a snapshot when the problem occurred and restoring the snapshot to replicate the problem. However, in this methodology as well the resources involved as well as the infrastructure required carries a high monetary cost.

One solution to the cost problem is to serialize the validation of the functionality and delay the release of features to market, thereby only requiring the resources and infrastructure to validate a single feature at a time. However, this may lead to reduced feature availability within a distributed computing network, delay of certain feature releases, and potentially delay of the distributed computing network release as well.

A system and apparatus are disclosed herein that allows the creation of containers for each functionality where each container represents the objective function which is a function of segmented demand model.

In one general embodiment for deploying a feature to a secure distributed computing network, initially a container image including tools for validation is created and pushed to an artifactory. The container image is pulled from the artifactory into a deployer and into a tools repository. A new container is created, and a container image is created of the containers including the new container and the tools repository to create a tarball in the deployer. The container image is periodically checked for a new container image by the artifactory using an Autodiscovery function. When a new container image is detected, the system creates a local user and stores the user key for the local user in a keyring. Then, the container image tarball is exported using that user and from the deployer into the storage nodes of the secured distributed computing network. The tarball is extracted on a selected storage node or storage node where debugging is to be performed, and the container operations from the tarball are executed. The Autodiscover is performed to determine which storage node should receive the container. For Autodiscover on pushing the container as a zip/tar into a specific storage nodes, a system device controller inventory of datatype variable is created through service discovery protocol. A device controller inventory list is created by means of device service tag and a device inventory classification is formed based on mapping of roles across different storage nodes. The results of the container operations are stored in a specific directory. The results from the specific directory are copied back to the deployer once the command has been executed, and the container is cleaned up.

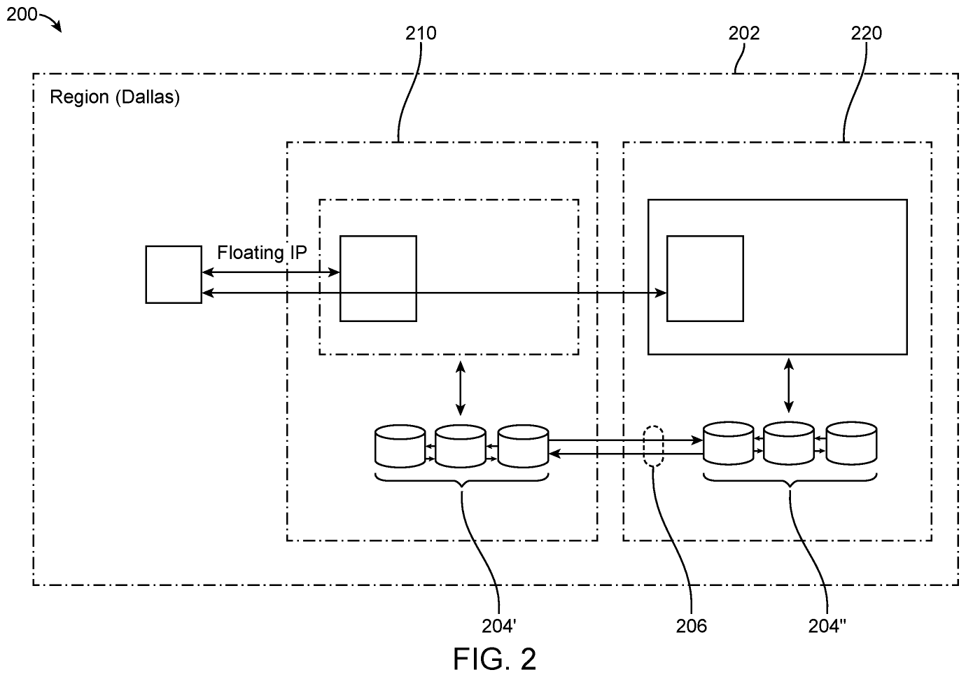

Turning now to a more detailed description of aspects of the present invention, FIG. 2 illustrates a distributed computing system 200 capable of implementing the processes described herein. As data growth happens exponentially within a distributed computing system 200, the resource optimization becomes challenging and data storage services cost grows in an exuberant manner. Considering more hardware resources are needed to build a solution, DevOps and to validate a feature, there is an enormous cost spent in developing the data center.

Moreover, to have dedicated systems for measuring the input/output operations per second (IOPS) and throughput of data pertaining to internal network and fine tuning the configuration parameters requires an organization to have a dedicated environment. Additionally, whenever an issue happens in a production environment, where the issue needs to be reproduced in development environment for debugging, a developer will require dedicated hardware to reproduce the problem.

To provide the configuration data integrity of a distributed computing resource, FIG. 2 illustrates an embodiment of hierarchical layered distributed computing system 200 environment.

The distributed computing system 200 includes multi zone regions zone1 210 and zone2 220 within a region 202. Each multi zone region 210, 220 includes a corresponding set of storage resources 204′, 204″ (referred to collectively as storage resources 204). In some examples, the storage resources 204 can be shared across the zones 210, 220 within a region 202. In the illustrated example, each region 210, 220 can have its own dedicated storage resources 204. Thus, for each multi zone 202 a group of software defined storage clusters (e.g. clusters of storage nodes) is provisioned within the storage resources 204 and dedicated storage resources 204 are interconnected. In examples where the storage resources are shared across zones, the storage resources 204 include an additional interconnection 206 between the zones 210, 220. While illustrated in the example of FIG. 2 as two regions, it is appreciated that any number of regions can be utilized and interconnected in similar manners.

In one particular example when a new storage platform upgrade or a new storage feature (e.g., a backup or snapshot functionality) is getting developed, an object like “container” specific to those functions based on demand is provisioned in the storage resources 204.

To validate if there are performance changes between different development builds, a container object like “performance container” is provisioned in the storage resources 204 and this container has necessary tools like input/output operation tools.

Once the code gets exercised, the container is brought down which frees up the resources for other functionality code to be executed. For the other functionality code execution, a new container object including pre-checks and a vulnerability scan is executed and once the container is provisioned, the corresponding tests are performed on the container.

Another object container (e.g., a “datapath validation” container) is provisioned which again undergoes all the pre-check and vulnerability validation. Once the container is up and running, the datapath validation is performed on that container and once the validation is completed, the container is brought down.

Another object container (e.g., a “terraform container”) is provisioned and activities pertaining to terraform workload like provisioning the virtual server instance with a greater number of volumes attached to the virtual server instance is provisioned.

In one example, a storage platform in a distributed computing network is not connected to the external world because of security and compliance requirements. The primary distributed storage node in such an example is protected from all users, and users are not able to log in to storage nodes using ssh. Further, there is no public IP address associated with the distributed storage nodes. To validate there is no disk error or disk performance is up to satisfaction level or even the health check of the storage cluster nodes, the user has a requirement to log in to the storage nodes without having access to the storage nodes.

In another similar example, in a zero-touch deployment and upgrade of storage nodes and storage nodes upgrades under input/output (IO) workloads requires validating that the impact of the IO is within bounds. Data integrity of the storage node validation and ensuring the storage node data availability is again required without user access or login to storage nodes.

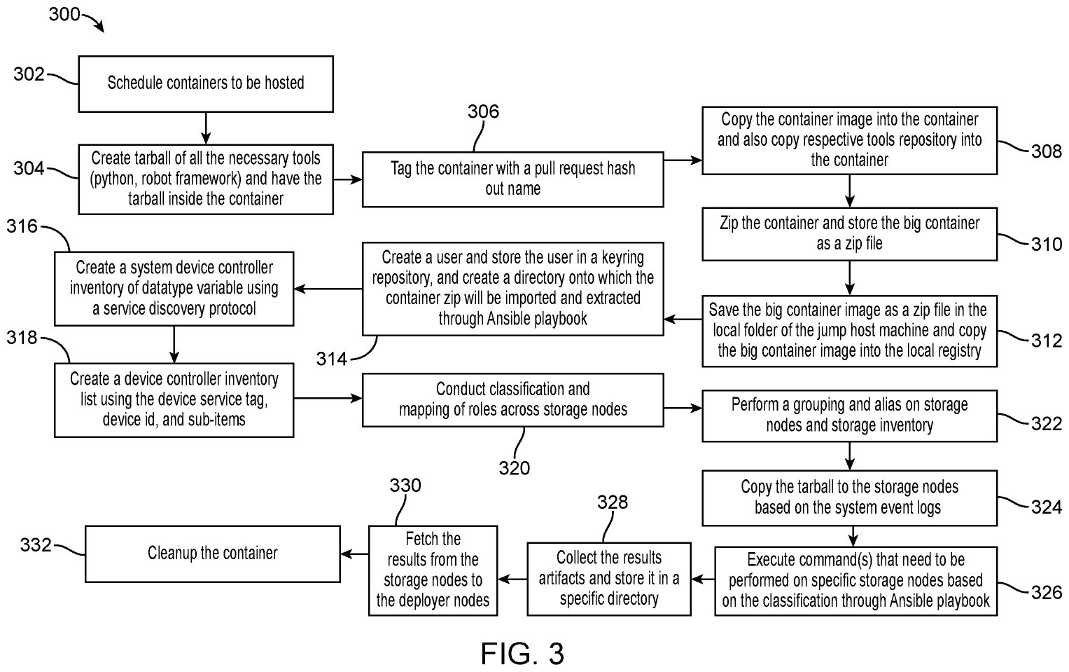

With continued reference to FIG. 2, FIG. 3 illustrates one example process 300 for granting the validation ability without user access or login.

In a general example, initially, a set of containers which are specific functionality are scheduled to be hosted on the storage platform. Subsequently, an object container named “performance container” is created using a scheduler and a pre-check of that container is triggered. Once the pre-check completes a vulnerability scan is applied to that container. Once the vulnerability checks are completed the container is hosted on the storage platform by provisioning functionality specific containers. It is appreciated that the specific names of objects, containers, and the like are exemplary only and are provided for ease of explanation.

After the functionality specific containers are provisioned, and when a new platform build is available, the validation of IOPS and throughput of the data is measured on that container.

This process is repeated, such that for each functionality a function specific container is provisioned which validates the functionality and once the functionality is completed the corresponding containers are brought down.

In an alternate general example, initially a docker image container is created from a deployer with all the tools that are required for storage platform validation. By way of example, the tools can include a robot framework and/or an operating system. The containers are tagged with a pull request hash out name so that the system can uniquely to identify the container name. Once the container is created, the container is pushed to a repository and the container image is saved as a zip file (or other similar compressive file type) within the local folder by means of pulling the container image from the repository.

Once saved the container is executed inside the deployer like platform-storage container where one would have copied the container image zip file created in previous step as well as the deployer tools directory and from that container an ansible playbook is called. The ansible playbook creates a local user on the storage platform and stores the local user in a keyring repository. The container image zip file is distributed to all the storage node clusters as well as the tools directory, through the ansible playbook, from the container that was created in. The container image zip file creates a local registry in the storage node through ansible playbook import. The playbook spins a new container in the distributed storage node with the imported local image along with the tools that were copied to the storage node cluster and validation of the playbook is executed through the container.

The playbook also create a role and a task at as part of an Autodiscover capability. The role and task decides when the new container image needs to be created (tracks tools updates, new scripts available etc.) and pushed to the repository and notify the admins once new image is available.

If there is newer version of the repository of tools in the deployer from the time the tarball is created and there is an addition of new scripts, the playbook initiates a copy of the latest container image as a tarball from the deployer through the Autodiscover capability and pushes the tarball to the disconnected nodes based on the new container image availability. Otherwise is skipped and the current tarball is pushed to the disconnected nodes based on the current image availability at.

In similar manner, if a performance metric validation of the storage node is desired, we will create a container image with all the tools in place and create the container image, push the container image to a repository and then save the container image as a zip file.

In the specific example of FIG. 3 initially, a set of containers which are specific functionality are scheduled to be hosted on the storage platform in a step 302. Then a tarball is created containing all the necessary tools (e.g., python framework, robot framework, etc.) and the tarball is placed inside a first container in a step 304. The first container is tagged with a pull request hash out name in a step 306. The pull request hash out name provides a unique container name for the container. Then a container image of the first container is copied into a second (big) container, and the image also includes a copy of any respective tools repositories within the first container in a step 308.

Once the required tools and the corresponding container images are copied inside the second container, the image of the first container is compressed and stored within the second container in a step 310. In one example, the compression can be zip compression, and the compressed file is a .zip format.

Then, an image of the second container is saved as a compressed file with the local folder of a jump host machine and copied into the local registry in a step 312. Once stored in the local registry, a user is created and stored in a keyring repository, and a directory is created onto which the image of the second container is imported and extracted using Ansible playbook in a step 314.

To facilitate auto discovery on pushing the second container as a compressed file into a specific storage node, a system device controller inventory of a datatype variable is created using a service discovery protocol in a step 316.

Using Ansible playbook, a device controller inventory list is created by using a device service tag, device id, and any sub-items associated with the device in a step 318. From the Ansible device inventory, a classification and mapping of roles across storage nodes is conducted for the items within the second container in a step 320.

Once the classification of the various storage nodes is performed, a grouping and aliasing of the tools is done on the storage nodes, and a storage inventory is created in a step 322. The tarball is copied to the storage nodes based on system event logs (e.g., the node the disk is on is replaced) in a step 324. The even logs can be obtained using any number of available tools including an intelligent platform management interface (IPMI) and/or Redfish. In this step, any commands that need to be executed from the tarball are identified. Then, the commands that have been identified are executed on the specific storage nodes based on the classification using Ansible playbook in step 326. The results of the commands are collected and stored in a specific corresponding directory in a step 328. The stored results are then fetched from the storage nodes to the deployer nodes in a step 330., and the container is cleaned up by removing the user and making the container state as being “absent” in a step 332.

By implementing the system described herein, an object function which is specific to distributed computing functionality containers can be created on need basis on the storage platform. This enables the system to have multiple containers running on the storage platform, and saves the storage hardware resources as well as optimizes the storage hardware utilization. In addition, the system provides an efficient use of storage hardware across devops which improves the storage hardware utilization as well as improves the efficiency in validating the functionality.

The system incorporates a new Autodiscover capability that is in place and decides when the new container image needs to be created (tracks tools updates, new scripts available, etc.) and pushed to the repository and notify the admins once a new image is available and a new Autodiscover capability which decides pushing the required container to the distributed storage nodes and to the disconnected nodes. The Autodiscover eliminates an additional hardware requirement for creating the customer like environment and most of the validation can be contained in a container.

The system also provides a method of bringing validation tools to distributed storage systems that have no ability to pull those tools from the internet or from any other external source due to security validation.

The system also provides a method of creating the container image with all relevant tools that are needed for a platform storage service validation, a method of pushing a tarball container image of disconnected nodes via pull from a local antifactory, and a method of pushing the container to the distributed storages. Once the container pushes the required tarball, the push includes the push to the disconnected nodes.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet microservice Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
validating a distributed computing storage platform with zero-touch storage node containers by;
creating a container image including a tools repository,
pushing the container image to a repository,
pulling the container image from the repository a local folder and saving the container image in the local folder,
creating a container to import the container image as well as tools repository into a plurality of storage nodes,
creating an ansible inventory configured to group the plurality of storage nodes and creating an alias for each group in the plurality of storage nodes,
extracting the container and copying the tarball from the container into the storage nodes,
unziping the tarball on each of the storage nodes in the plurality of storage nodes, executing the storage operations and storing results of the storage operations in a specific directory,
collecting the results of each executed storage operation, and
logging back to the local folder after a command is executed and cleaning up the container.

2. The method of claim 1, wherein the tools repository includes at least validation tools.

3. The method of claim 1, wherein the plurality of storage nodes are groups and aliased based on storage characteristics of each individual storage node.

4. The method of claim 1, wherein the zero-touch storage node containers are disconnected from the internet and lack login access privilege.

5. The method of claim 1, wherein the tarball is selected from a plurality of tarballs, and wherein each tarball in the plurality of tarballs includes distinct container images.

6. The method of claim 5, wherein the plurality of storage nodes is a cluster configuration, and wherein each storage node in the cluster configuration is validated using a different set of container images contained in the tarball.

7. The method of claim 6 further comprising identifying a tarball corresponding to each storage node in the plurality of storage nodes and pushing the identified tarball to the corresponding storage node.

8. The method of claim 1, wherein the distributed computing storage platform includes an Autodiscover capability configured to identify when a new container image should be created and pushed to the repository.

9. The method of claim 8, wherein the Autodiscover capability identifies when the new container image should be created by identifying at least one of a tool update and a new script being available.

10. A computer program product comprising:
a non-transitory computer readable medium storing instructions for causing a processor to implement a method for validating a distributed computing storage platform with zero-touch storage node containers by;
creating a container image including a tools repository,
pushing the container image to a repository,
pulling the container image from the repository a local folder and saving the container image in the local folder,
creating a container to import the container image as well as tools repository into a plurality of storage nodes,
creating an ansible inventory configured to group the plurality of storage nodes and creating an alias for each group in the plurality of storage nodes,
extracting the container and copying the tarball from the container into the storage nodes,
unziping the tarball on each of the storage nodes in the plurality of storage nodes, executing the storage operations and storing results of the storage operations in a specific directory,
collecting the results of each executed storage operation, and
logging back to the local folder after a command is executed and cleaning up the container.

11. The computer program product of claim 10, wherein the tools repository includes at least validation tools.

12. The computer program product of claim 10, wherein the plurality of storage nodes are groups and aliased based on storage characteristics of each individual storage node.

13. The computer program product of claim 10, wherein the zero-touch storage node containers are disconnected from the internet and lack login access privilege.

14. The computer program product of claim 10, wherein the tarball is selected from a plurality of tarballs, and wherein each tarball in the plurality of tarballs includes distinct container images.

15. The computer program product of claim 14, wherein the plurality of storage nodes is a cluster configuration, and wherein each storage node in the cluster configuration is validated using a different set of container images contained in the tarball.

16. The computer program product of claim 15 further comprising identifying a tarball corresponding to each storage node in the plurality of storage nodes and pushing the identified tarball to the corresponding storage node.

17. The computer program product of claim 10, wherein the distributed computing storage platform includes an Autodiscover capability configured to identify when a new container image should be created and pushed to the repository.

18. The computer program product of claim 17, wherein the Autodiscover capability identifies when the new container image should be created by identifying at least one of a tool update and a new script being available.

19. A system comprising:
a plurality of interconnected computational systems including a plurality of zero touch storage node containers and at least one processor configured to implement a method for validating the plurality of zero touch storage nodes by;
creating a container image including a tools repository,
pushing the container image to a repository,
pulling the container image from the repository a local folder and saving the container image in the local folder,
creating a container to import the container image as well as tools repository into a plurality of storage nodes,
creating an ansible inventory configured to group the plurality of storage nodes and creating an alias for each group in the plurality of storage nodes,
extracting the container and copying the tarball from the container into the storage nodes,
unziping the tarball on each of the storage nodes in the plurality of storage nodes, executing the storage operations and storing results of the storage operations in a specific directory,
collecting the results of each executed storage operation, and
logging back to the local folder after a command is executed and cleaning up the container.

20. The system of claim 19, wherein the plurality of zero-touch storage node containers are disconnected from the internet and lack login access privilege.
